(19) United States
(12) Patent Application Publication
(10) Pub. No.: US 2006/0129399 A1
(43) Pub. Date: Jun. 15, 2006

(54) Speech conversion system and method

(75) Inventors: Oytun Turk, Istanbul (TR); Levent M. Arslan, Istanbul (TR)

Correspondence Address: PAUL, HASTINGS, JANOFSKY & WALKER LLP, P.O. BOX 919092, SAN DIEGO, CA, 92191-9092, US

(73) Assignee: Voxonic, Inc., New York, NY (US)

(21) Appl. No.: 11/271,325

(22) Filed: Nov. 10, 2005

Related U.S. Application Data
(60) Provisional application No. 60/626,898, filed on Nov. 10, 2004.

(51) Int. Cl. G10L 15/14

(52) U.S. Cl. 704/256

(57) ABSTRACT

The conversion of speech can be used to transform an utterance by a source speaker to match the speech characteristic of a target speaker. During a training phase, utterances corresponding to the same sentences by both the target speaker can source speaker can be force aligned according to the phonemes within the sentences. A target codebook and source codebook as well as a transformation between the two can be trained. After the completion of a training phase, a source utterance can be divided into entries in the source codebook and transformed into entries in the target codebook. During the transformation, the situation arises where a single source codebook entry can have several target codebook entries. The number of entries can be reduced with the application of confidence measures.

### RELATED APPLICATION

This application claims the benefit of priority to U.S. Provisional Application Ser. No. 60/626,898, filed on Nov. 10, 2004, the disclosure of which is incorporated herein by reference in its entirety.

### BACKGROUND OF INVENTION

1. Field of Invention

The present invention relates to speech conversion and more particularly, to a system and method in which utterances of a person are used to synthesize new speech while maintaining the same vocal characteristics. The system and method may be used, for example, in the entertainment field and other media involving speech processing.

2. Description of Related Art

In the field of entertainment, after a program such as a movie is recorded in one language, using featured actors, it is often desirable to convert or dub sounds from the program to a second language to allow the program to be viewed by people conversant in the second language. Typically, this process is accomplished by generating a new script in the second language and then using dubbing actors conversant in the second language to perform the new script, generating a second recording of this latter performance and then superimposing the new recording on the program. This process is relatively expensive as it requires a whole new cast to perform the second script. It is also time consuming. Generally, it takes about several weeks to dub a standard 90-minute movie. Finally, dubbing sounds is a specialized endeavor and the number of dubbing actors who are involved in dubbing is relatively small, especially in some of the less popular languages, forcing studios to use the same dubbing actors over and over again for different movies. As a result, many movies have different featured actors, but if the same dubbing actors are used, they will sound the same.

FIG. 1 illustrates an example of the traditional method of dubbing a program, such as a movie. An English-speaking feature actor 10 utters many English sentences 12 based on an English script 13. Sentences 12 are recorded electronically in any convenient form together with sentences uttered by other actors, special sound effects, etc., to generate an English sound track. The movie and its English sound track can be distributed in step 14 to English-speaking audiences.

In addition, the English script 13 can be translated into a corresponding Spanish script 15. The translation can be performed by a human translator or by a computer using appropriate software. The Spanish script 15 can be given, for example, to a Spanish dubbing actor 16 who then utters Spanish sentences 18 corresponding to the English sentences 12 and mimicking the dramatic delivery of feature actor 10. In a conventional process, a Spanish audio track can be generated at step 28 and then superimposed on an English sound track as described. The resulting dubbed Spanish movie can then be distributed to Spanish audiences at step 30.

A voice conversion system receives speech from one speaker and transforms the speech to sound like the speech of another speaker. Speech conversion is useful in a variety of applications. For example, a speech recognition system may be trained to recognize a specific person's voice or a normalized composite of voices. Speech conversion as a front-end to the speech recognition system allows a new person to effectively utilize the system by converting the new person's speech into the voice that the speech recognition system is adapted to recognize. As a post processing step, speech conversion changes the speech of a text-to-speech synthesizer. Speech conversion may also be employed for speech disguising, dialect modification, foreign-language dubbing to retain the voice of an original actor, and novelty systems such as celebrity voice impersonation, for example, in Karaoke machines.

In order to convert speech from a “source” speech to a “target” speech, codebooks of the source speech and target speech are typically prepared in a training phase. A codebook is a collection of “phones,” which are units of voice sounds that a person utters. For example, the spoken English word “cat” in the General American dialect comprises three phones [K], [A-E], and [T], and the word “cot” comprises three phones [K], [AA], and [T]. In this example, “cat” and “cot” share the initial and final consonants, but employ different vowels. Codebooks are structured to provide a one-to-one mapping between the phone entries in a source codebook and the phone entries in the target codebook. In a conventional speech conversion system using a codebook approach, an input signal from a source speaker is sampled and preprocessed by segmentation into “frames” corresponding to a voice unit. Each frame is matched to the “closest” source codebook entry and then mapped to the corresponding target codebook entry to obtain a phone in the voice of the target speaker. The mapped frames are concatenated to produce speech in the target voice. A disadvantage with this and similar conventional speech conversion systems is the introduction of artifacts at frame boundaries leading to a rather rough transition across target frames. Furthermore, the variation between the sound of the input voice frame and the closest matching source codebook entry is discarded, leading to a low quality speech conversion.

Previous codebook concepts, enforced several speech units to be modeled by a single entry, limiting the resolution of speech conversion system. FIG. 2 depicts an exemplary codebook for a source speaker and a target speaker each comprising an entry for each of 64 phones. In this example the source speaker entries are shown by the solid lines representing the average of all centroid line spectral frequency (LSF) vectors and the target speaker entries are likewise shown by the dotted lines. Since vowel quality often depends on the length and stress of the vowel, a plurality of vowel phones for a particular vowel, for example, [AA], [AA1], and [AA2], are ofthen included in the exemplary codebook.

A common cause for the variation between the sounds in voice and in codebook is that sounds differ depending on their position in a word. For example, the /t/ phoneme has several “allophones.” At the beginning of a word, as in the General American pronunciation of the word “top,” the /t/ phoneme is an unvoiced, fortis, aspirated, alveolar stop. In an initial cluster with an /s/, as in the word “stop,” it is an unvoiced, fortis, unaspirated, alveolar stop. In the middle of a word between vowels, as in “potter,” it is an alveolar flap. At the end of a word, as in “pot,” it is an unvoiced, lenis, unaspirated, alveolar stop. Although the allophones of a consonant like /t/ are pronounced differently, a codebook with only one entry for the /t/ phoneme will produce only one kind of /t/ sound and, hence, unconvincing output. Prosody also accounts for differences in sound, since a consonant or vowel will sound somewhat different when spoken at a higher or lower pitch, more or less rapidly, and with greater or lesser emphasis.

One conventional attempt to improve speech conversion quality is to greatly increase the amount of training data and the number of codebook entries to account for the different allophones of the same phoneme and different prosodic conditions. Greater codebook sizes lead to increased storage and computational overhead. Conventional speech conversion systems also suffer in a loss of quality because they typically perform their codebook mapping in an acoustic space defined by linear predictive coding coefficients. Linear predictive coding (LPC) is an all-pole modeling of voice and, hence, does not adequately represent the zeroes in a voice signal, which are more commonly found in nasal and sounds not originating at the glottis. Linear predictive coding also has difficulties with higher pitched sounds, for example, women's voices and children's voices.

A traditional approach to such a problem employs a training phase where input speech training data from source and target speakers are used to formulate a spectral transformation that attempt to map the acoustic space of the source speaker to that of the target speaker. The acoustic space can be characterized by a number of possible acoustic features which have been studied extensively in the past. The most popular features used for speech transformation include formant frequencies and LPC spectrum coefficients. The transformation is in general based on codebook mapping. That is, a one to one correspondence between the spectral codebook entries of the source speaker and the target speaker is developed by some form of supervised vector quantization method. Such methods often face several problems such as artifacts introduced at the boundaries between successive voice frames, limitation on robust estimation of parameters (e.g., formant frequency estimation), or distortion introduced during synthesis of target voice. Another issue which has not been explored in detail is the transformation of the excitation characteristics in addition to the vocal tract characteristics.

Another difficulty arises when associating phonemes or phones with a given source or target utterance. Traditionally, phonemes or phones are associated with an utterance by obtaining an orthographic transcription of the utterance, that is, a transcript of the utterance written with symbols of that language. A phonetic translation of the orthographic transcription is made and the utterance is then aligned to the phonetic translation. This process can consume a great deal of resources particularly in an environment where an orthographic transcription is not readily available in the form of a script, for example, on a live program.

In another previous method the speech model for an utterance was being generated from source speaker's utterance only, and the target utterance was force aligned to that speech model. Such a model only included speech from a single speaker, if there is a large mismatch between source and target speaker acoustic space then alignment performance was degrading.

A further disadvantage of existing systems is that many media use high quality digital audio tracks with sampling rates of 44 kHz or more. Previous speech conversion schemes could not be readily adapted to handle such high rates and accordingly they are not able to provide a high quality sound.

### SUMMARY OF THE INVENTION

The present invention overcomes these and other deficiencies of the prior art by providing a method of aligning source and target utterances during the training phase without the need for an orthographic transcription of the utterances. As a result a source codebook, target codebook and transformation between the two can be trained. Additionally, all possible information regarding the mapping is retained intact. Furthermore, when a one to many mapping of source to target codebook entries situation occurs in mapping a previously untransformed source utterance into a target utterance, confidence measures are applied to select the closest matching target codebook entries.

In one embodiment of the invention, the speech conversion system recognizes phonemes in a source utterance spoken by a source speaker having vocal source speaker vocal characteristics, then subdivides the utterance into source frames where each frame contains a phoneme. For each frame, the system then matches a Hidden Markov Model (HMM) state in source codebook generated in a training phase and selects a plurality of target HMM states from a target codebook. The system eliminates anomalous or insignificant target HMM states, for example, by applying confidence measures and averages the remaining HMM states. The resulting transformed HMM states are assembled into a target utterance with the vocal characteristics of the target speaker. In one aspect of the invention, the HMM states are based on the spectral line frequencies.

In another embodiment of the invention, the codebooks are generated by selecting each utterance in a source training set of utterances spoken by the source speaker, recognizing all. phonemes in each utterance in the source training set, and training an HMM for each phoneme. The source to target transformation is trained by associating all HMM states in the source codebook for each phoneme with the corresponding HMM states in the target codebook for the same phoneme.

To eliminate the potential problem when there is a large mismatch between source and target speaker acoustic space, a speaker independent model is generated based on the source speaker utterance. Another major advantage is to apply confidence measures to eliminate possibly bad entries in the codebooks.

The foregoing, and other features and advantages of the invention, will be apparent from the following, more particular description of the embodiments of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 shows a traditional speech conversion process;

FIG. 2 depicts exemplary codebook entries for in a traditional codebook;

FIG. 3 illustrates a computer-based speech conversion system according to an embodiment of the invention;

FIG. 4 shows a speech conversion process according to an embodiment of the invention;

FIG. 5 shows a flowchart for defining codebooks using training sentences according to an embodiment of the invention;

FIG. 6 shows graphically the state alignments for the source and target speaker utterances for the template sentence ‘she had your’;

FIG. 7 is a set of graphs illustrating the one-to-many mapping problem which occurs with a basic phonemic alignment approach;

FIG. 8 is a set of graphs illustrating two source and target state pairs that are eliminated because the spectral distance confidence measures;

FIG. 9 is a set of histograms illustrating source-target state pairs that are eliminated due to the spectral distance confidence measures;

FIG. 10 is a set of graphs illustrating a source HMM state and a target HMM state that comprise a pair eliminated due to the f₀ distance confidence measures;

FIG. 11 is a set of histograms illustrating source-target state pairs that are eliminated due to the f₀ distance confidence measures;

FIG. 12 is a set of graphs illustrating a source HMM state and a target HMM state that comprise a pair eliminated due to the average energy distance confidence measures;

FIG. 13 is a set of histograms illustrating source-target state pairs that are eliminated due to the average energy distance confidence measures;

FIG. 14 is a set of graphs illustrating a source HMM state and a target HMM state that comprise a pair eliminated due to the duration distance confidence measures; and

FIG. 15 is a set of histograms illustrating source-target state pairs that are eliminated due to the duration distance confidence measures.

### DETAILED DESCRIPTION OF EMBODIMENTS

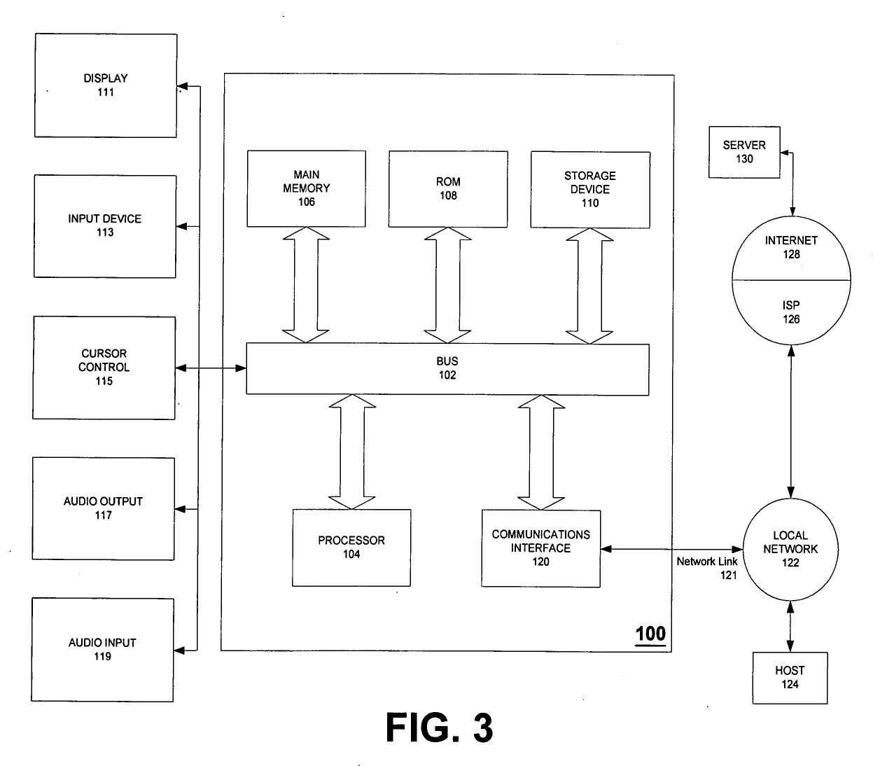

Further features and advantages of the invention, as well as the structure and operation of various embodiments of the invention, are described in detail below with reference to the accompanying FIGS. 3-15, wherein like reference numerals refer to like elements. In the following description, for the purposes of explanation, numerous specific details are set forth in order to provide a thorough understanding of the present invention. It will be apparent, however, to one of ordinary skill in the art that the present invention may be practiced without these specific details. In other instances, well-known structures and devices are shown in block diagram form in order to avoid unnecessarily obscuring the systems and methods described herein.

### Hardware Overview

FIG. 3 is a block diagram that illustrates a computer-based speech conversion system 100 according to an embodiment of the invention. The system 100 comprises a bus 102 or other communication mechanism for communicating information, and a processor (or a plurality of central processing units working in cooperation) 104 coupled with bus 102 for processing information. System 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. System 100 further includes a read only memory (ROM) 108 and/or other static storage device coupled to bus 102 for storing static information and instructions for processor 104. A storage device 110, such as a magnetic disk, optical disk, CD or DVD is provided and coupled to bus 102 for storing information and instructions. System 100 may be coupled via bus 102 to a display 111, for displaying information to a computer user. An input device 113, including alphanumeric and other keys, is coupled to bus 102 for communicating information and command selections to processor 104. Another type of user input device can be a cursor control 115, such as a mouse, a trackball, or cursor direction keys for communicating direction information and command selections to processor 104 and for controlling cursor movement on display 111. Such an input device typically has two degrees of freedom in two axes, a first axis (e.g., x) and a second axis (e.g., y), that allows the device to specify positions in a plane. For audio output and input, system 100 can be coupled to a speaker 117 and a microphone 119, respectively.

In an embodiment of the invention, speech conversion is provided by system 100 in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein.

One or more processors in a multi-processing arrangement may also be employed to execute the sequences of instructions contained in main memory 106. In alternative embodiments, hard-wired circuitry may be used in place of or in combination with software instructions to implement the systems and methods described herein. Thus, the systems and methods described are not limited to any specific combination of hardware circuitry and software.

The term “computer-readable medium” as used herein refers to any medium, the identification and implementation of which is apparent to one of ordinary skill in the art, that participates in providing instructions to processor 104 for execution. Such a medium can take many forms, including but not limited to, non-volatile media, volatile media, and transmission media. Non-volatile media include, for example, optical or magnetic disks, such as storage device 110. Volatile media include dynamic memory, such as main memory 106. Transmission media include coaxial cables, copper wire and fiber optics, including the wires that comprise bus 102. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a compact disc ROM (CD-ROM), digital video disc (DVD), any other optical medium, punch cards, paper tape, any other physical medium with patterns of holes, a RAM, a programmable ROM (PROM), and erasable PROM (EPROM), a FLASH-EPROM, any other memory chip or cartridge, a carrier, wave as described hereinafter, or any other medium from which a computer can read.

Various forms of computer readable media can be involved in carrying one or more sequences of one or more instructions to processor 104 for execution. For example, the instructions can initially be borne on a magnetic disk of a remote computer. The remote computer can load the instructions into its dynamic memory and send the instructions over a telephone line using a modem. A modem local to computer system 100 can receive the data on the telephone line and use an infrared transmitter to convert the data to an infrared signal. An infrared detector coupled to bus 102 can receive the data carried in the infrared signal and place the data on bus 102. Bus 102 carries the data to main memory 106, from which processor 104 retrieves and executes the instructions. The instructions received by main memory 106 can optionally be stored on storage device 110 either before or after execution by processor 104.

System 100 may also include a communication interface 120 coupled to bus 102. Communication interface 120 provides a two-way data communication coupling to a network link 121 that is connected to a local network 122. Examples of communication interface 120 include an integrated services digital network (ISDN) card, a modem to provide a data communication connection to a corresponding type of telephone line, and a local area network (LAN) card to provide a data communication connection to a compatible LAN. Wireless links can also be implemented. In any such implementation, communication interface 120 sends and receives electrical, electromagnetic or optical signals that carry digital data streams representing various types of information. Network link 121 typically provides data communication through one or more networks to other data devices. For example, network link 121 can provide a connection through local network 122 to a host computer 124 or to data equipment operated by an Internet Service Provider (ISP) 126. ISP 126 in turn provides data communication services through the worldwide packet data communication network, now commonly referred to as the Internet 128. Local network 122 and Internet 128 both use electrical, electromagnetic or optical signals that carry digital data streams. The signals through the various networks and the signals on network link 121 and through communication interface 120, which carry the digital data to and from system 100, are exemplary forms of carrier waves transporting the information.

System 100 can send messages and receive data, including program code, through the network(s), network link 121, and communication interface 120. In an Internet example, a server 130 might transmit a requested code for an application program through Internet 128, ISP 126, local network 122 and communication interface 120. In accordance with one embodiment, one such downloaded application provides for speech conversion as described herein. The received code can be executed by processor 104 as it is received, and/or stored in storage device 110, or other non-volatile storage for later execution. In this manner, system 100 can obtain application code in the form of a carrier wave.

### General Overview

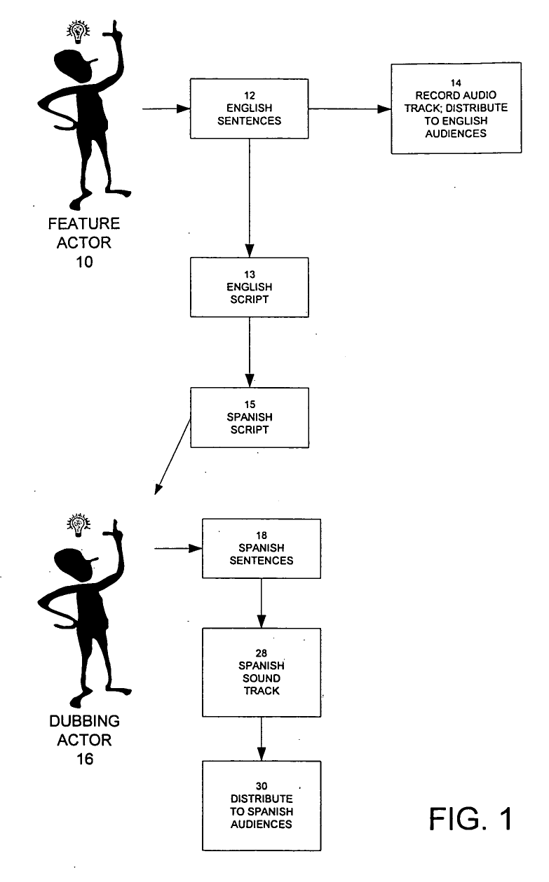

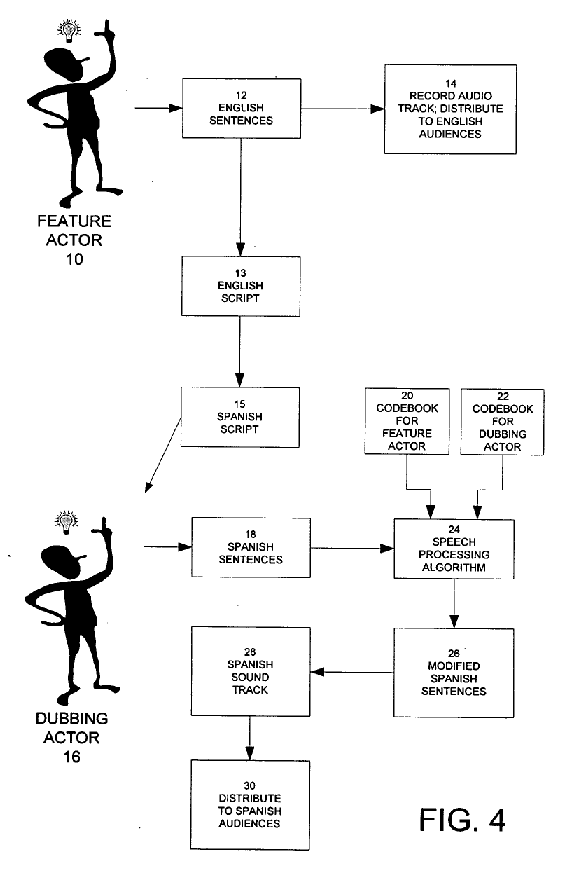

In an embodiment of the invention, system 100 converts a person's speech into a form that is recognizable as originating from the person, but not in the original language. For example, referring to FIG. 4, steps 11-15 and step 18 are performed as described above for FIG. 1. However, the generation of the Spanish soundtrack uses speech conversion system 100 to make the voice of dubbing actor 16 have the vocal characteristics of feature actor 10. For example, system 100 is provided with two codebooks: a codebook 20 that characterizes the speech pattern and characteristics of feature actor 10, and a codebook 22 that characterizes the speech pattern and characteristics of the dubbing actor 16.

In step 24, Spanish sentences are electronically converted by system 100 using the algorithm discussed below and codebooks 20, 22 into modified Spanish sentences 26. Modified sentences 26 are in Spanish, but have characteristics substantially identical to the voice of feature actor 10. The modified sentences 26 are combined with similarly modified sentences corresponding to the voices of other feature actors to result in a Spanish sound track 28. This new dubbed sound track 28 can then be superimposed on the sound track of the original movie to generate a dubbed movie 30 that can be distributed (step 32) to Spanish audiences.

In the following discussion, the feature actor 10 corresponds to the target speaker or target voice and the dubbing actor 16 corresponds to the source speaker or source voice, while the corresponding codebooks can be termed the source and the target codebooks, respectively.

### Source and Target Codebooks

Codebooks 20 and 22 for the source voice and the target voice, respectively, are prepared as a preliminary step, using, processed samples of the source and target speech, respectively. The number of entries in the codebooks can vary from implementation to implementation and depend on a trade-off of conversion quality and computational tractability. For example, better conversion quality can be obtained by including a greater number of phones in various phonetic contexts, but at the expense of increased utilization of computing resources and a larger demand on training data. Preferably, the codebooks 20 and 22 include at least one entry for every phoneme in, the conversion language. However, the codebooks 20 and 22 can be augmented to include allophones of phonemes and common phoneme combinations can augment the codebook. Unlike conventional codebook concepts which enforced several speech units to be modeled by a single entry, entries in codebooks 20 and 22 retain all possible information regarding the mapping. Therefore a higher resolution is obtained in the transformation quality.

In an embodiment of the invention, the source and target vocal tract characteristics in the codebook entries are represented as line spectral frequencies (LSF). In contrast to conventional approaches using linear prediction coefficients (LPC) or formant frequencies, line spectral frequencies can be estimated quite reliably and have a fixed range useful for real-time digital signal processing implementation. In an embodiment of the invention, the line spectral frequency values for the source and target codebooks 20 and 22 are obtained by first determining for the sampled signal the linear predictive coefficients, aₖ, which are the set of parameters corresponding to a specific vocal tract configuration, where the vocal tract is modeled by an all-pole filter, and the filter coefficients are expressed as aₖ. Methods of determining of the LSF values are apparent to one of ordinary skill in the art. For example, specialized hardware, software executing on a general purpose computer or microprocessor, or a combination thereof, ascertains the linear predictive coefficients by such techniques as square-root or Cholesky decomposition, Levinson-Durbin recursion, and lattice analysis introduced by Itakura and Saito, the implementation of all of which are apparent to one of ordinary skill in the art.

In a conventional process, entries in the source codebook and the target codebooks are obtained by recording the speech of the source speaker and the target speaker, respectively, and converting them into phones. According to one training approach, the source and target speakers are asked to utter words and sentences for which an orthographic transcription is prepared. Each training speech is sampled at an appropriate frequency and automatically segmented using, for example, a forced alignment to a phonetic translation of the orthographic transcription within an Hidden Markov Model (HMM) framework using Mel-cepstrum coefficients and delta coefficients, the implementation of which is apparent to one of ordinary skill in the art. See, e.g., C. Wightman & D. Talkin, The Aligner User's Manual, Entropic Research Laboratory, Inc., Washington, D.C., (1994).

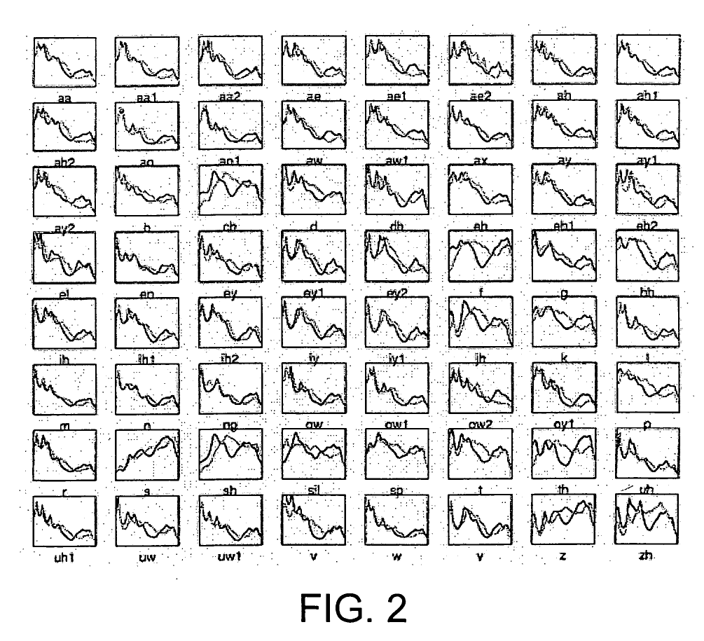

The line spectral frequencies for source and target speaker utterances are calculated on a frame-by-frame basis and each LSF vector is labeled using a phonetic segmenter. Next, a centroid LSF vector for each phoneme is estimated for both source and target speaker codebooks by averaging across all the corresponding speech frames. The estimated codebook spectra for an example male source speaker (solid) and female (dotted) target speaker combination from the database is shown in FIG. 2 when monophones are selected as speech units. A one-to-one mapping is established between the source and target codebooks to accomplish the voice transformation.

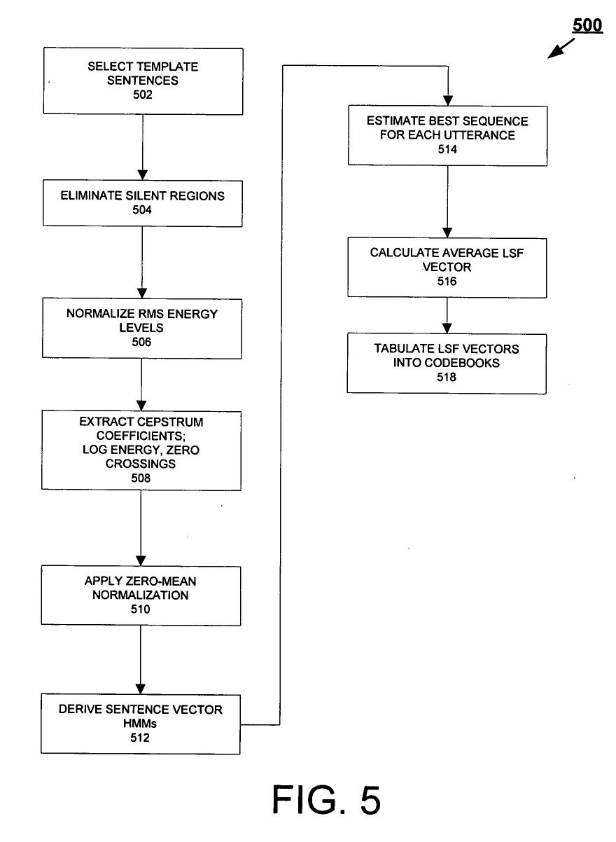

In an embodiment of the invention, codebooks 20 and 22 are generated a “Sentence HMM” method 500 as illustrated described in FIG. 5. Method 500 does not require the phonetic translation of the orthographic transcription for the training utterances. Method 500 assumes that both source and target speakers are speaking the same sentences during the training session. First, template sentences are selected (502) that are phonetically balanced, i.e., each phoneme appears with a similar number of times as possible to be uttered by the source and target speakers. After the training data, i.e., utterances of the template sentences are spoken by the source and target speakers, are collected, silence regions at the beginning and end of each utterance are removed (step 504). Each utterance is normalized (step 506) in terms of its Root-Mean-Square (RMS) energy to account for differences in the recording gain level. Next, spectrum coefficients are extracted (step 508) along with log-energy and zero-crossing for each analysis frame in utterance. Zero-mean normalization is optimally applied (step 510) to the parameter vector to obtain a more robust spectral estimate. Based on the parameter vector sequences, sentence HMMs are derived (step 512) for each template sentence using data from the source speaker. The number of states for each sentence vector HMM can be set proportional to the duration of the utterance.

In an embodiment of the invention, derivation of the HMMs is implemented using a segmental k-means algorithm followed by the Baum-Welch algorithm. The Baum-Welch algorithm estimates the parameters of a statistical model (Hidden Markov model) given a large amount of training data. Next, the best state sequence for each utterance is estimated (step 514) using a Viterbi algorithm. The Viterbi algorithm finds the most likely phoneme sequence for a given utterance based on the previously calculated statistics (from Baum-Welch) available for each phoneme.

The average LSF vector for each state is calculated (step 516) for both source and target speakers using frame vectors corresponding to that state index. Finally, these average LSF vectors for each sentence are tabulated (step 518) to build the source and target speaker codebooks.

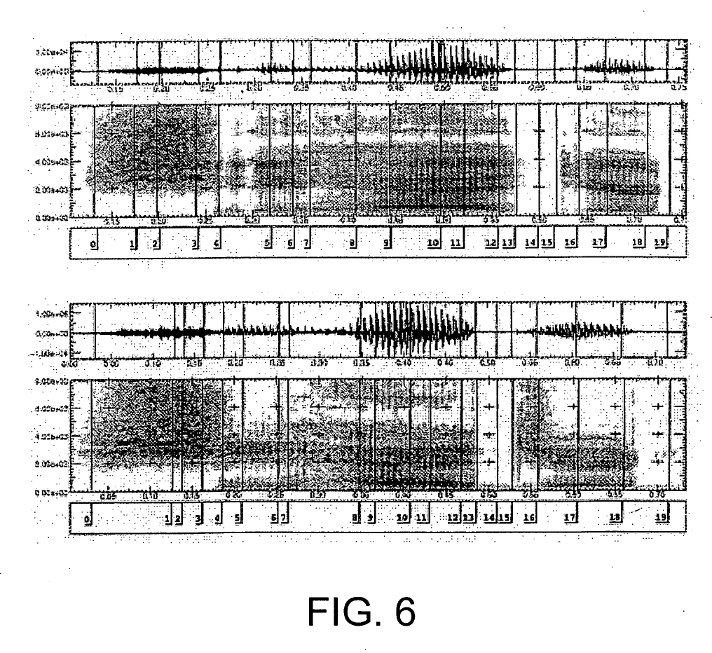

In FIG. 6, the alignments to the state indices using method 500, are shown for the template sentence “She had your” both for source and target speaker utterances. For both the source and target speakers, the recording and estimated spectra are shown. Furthermore, HMM states labeled from 0-19 are shown. From this figure, it can be seen that detailed acoustic alignment is achieved quite accurately using sentence HMMs.

In another embodiment of the invention, codebook generation is performed using phonemic alignment. Codebook generation by phonemic alignment uses a universal phoneme model that is developed to incorporate the phonemes in all the world's major languages. First, a collection of phoneme sets and speech data are collected from all of the world's major languages. Then, HMMs are then trained for each phoneme including the various allophone which can comprise the phoneme. Phoneme recognition is then applied to the source speaker's utterances. Then, force-alignment is performed of the source and target speakers' utterances with the recognized phoneme sequence. Finally, to insure accuracy, a number of confidence measures can be applied to eliminate large mismatched HMM states between the source and target speakers' utterances.

Unlike the conventional monophone codebooks, each phoneme in the codebooks generated by phonemic alignment method have multiple entries, for example, a collection of HMM states. The multiple entry codebooks allow for wider and more accurate representations of each phoneme but can also lead to a one-to-many problem, that is a source HMM states can be mapped to several possible target HMM states. especially when the source and target HMM states that are matched can have significantly different acoustical features. The application of a confidence measure, that is a metric which constrains the results to an acceptable predetermined range of possibilities.

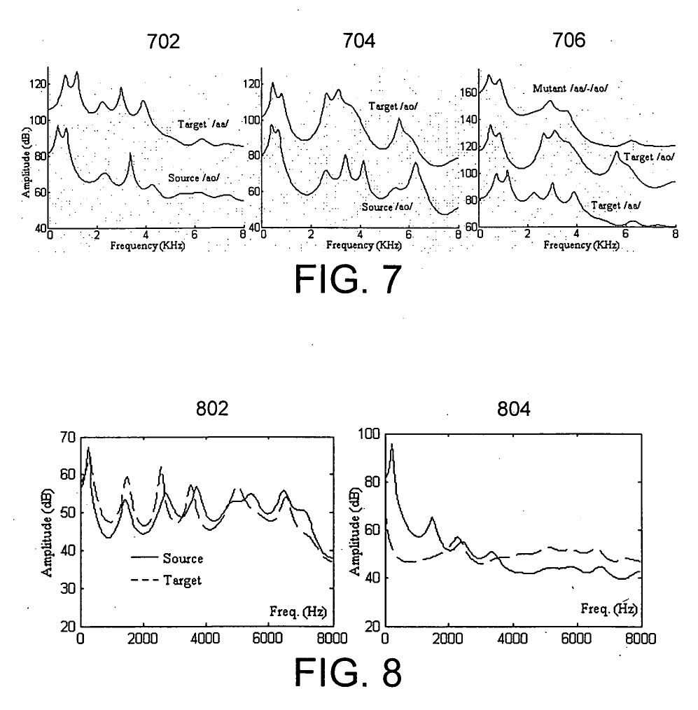

As an example, consider the situation where a source and target speakers have different accents. FIG. 7 shows an example where the source speaker is an English speaker with a Russian accent and the target speaker is a native American-English speaker. The utterance was recorded in English and alignment was performed manually to insure accuracy. Specifically, the utterance is “She has your dark suit in greasy wash water all year.” Graph 702 shows the phoneme /aa/ as in the word “w/a/sh” as pronounced by the source and target speakers. It should be noted that the Russian speaker pronounced it as the phone /ao/. Therefore, there is an incorrect match between the source and target states due to the differences in the accent of the speakers. Graph 704 shows the phoneme /ao/ in “/a/ll” as pronounced by the source and target speakers. It should be noted that in this case the /ao/ phonemes are matched. This results in the two source-target pairs /ao/-/aa/ and /ao/-/ao/. As a result, the phoneme /ao/ in any source utterance can have multiple target states in the acoustical space. In such a case of a one-to-many mapping, the results can be averaged resulting in a “mutant” phoneme lying acoustically between /ao/ and /aa/ as shown in Graph 706. However, if the acoustical properties of the source and target differ too greatly, the resultant target state could produce highly undesirable results. It should be noted that the spectra in FIG. 7 are shifted to along the vertical axis in order to clearly show the spectra of each phoneme.

Two approaches can be used to address the one-to-many mapping problem. One approach involves determining the appropriate target state to use when similar source states are matched with significantly different target states. This approach produces the most desirable conversion, but lacks practicality. In order to implement this approach, the exact description of source and target accents have to be obtained. Often, this is not practical because of a relatively limited amount of training data.

The second approach is to eliminate or reduce the one-to-many mappings from the codebooks by employing confidence measures to detect pairs of source and target states that are significantly different. Confidence measures can include spectral distance, f₀ distance, energy distance, duration difference or some combination thereof, to name just a few. Additionally, it is desirable to eliminate possible codebook matches where the difference between the source and target states are insignificant. If neighboring source speech frames are matched with significantly different codebook entries, a discontinuity in the output can be produced resulting in a distorted result. Thus, to mitigate this effect, codebook entries with significant differences between source and target states can be eliminated as well.

In using spectral distance as a confidence measure, the distance between a source LSF vector and a target LSF vector is calculated. If the distance exceeds a predetermined quantity, the source-target pair is eliminated from the codebook because the source and target states are acoustically very different as illustrated in an example shown in Graph 804 in FIG. 8, which depicts the spectra of the source and target states. If the distance is below a predetermined quantity, the source-target pair is eliminated from the code book because the source and target states are insignificantly acoustically different as illustrated in an example shown in Graph 802 in FIG. 8.

In an embodiment of the method, the spectral distance between a source LSF vector and a target LSF vector, ΔS, is calculated by

$$Δ S = {\sum }_{i = 1}^{P} \frac{\vert {k}_{i} - {h}_{i} \vert}{arg min ( \vert {k}_{i} - {k}_{i - 1} \vert , \vert {k}_{i} - {k}_{i + 1} \vert )}$$

where k denotes the source LSF vector and h denotes the target LSF vector (where kᵢ and hᵢ are the components of the vector k and h, respectively, and P is the dimension of the LSF vector space. The mean and standard deviation of ΔS values for all pairs of source and target HMM states are estimated, denoted by μΔs and σΔs respectively. If the spectral distance, ΔS, is greater than the mean by N/2 standard deviations, i.e., ΔS>μΔs+0.5 NσΔs, the source and target states are acoustically too different, and the pair is eliminated from the code book. If the spectral distance is less, than the mean by N/2 standard deviations, i.e., ΔS<μΔs−0.5 NσΔs, the source and target states are acoustically too similar and the pair is eliminated from the code book. The variable N is a tuning parameter and in practice the value of N=3 yields good results. An increase in N can result in more acceptance of more source-target pairs.

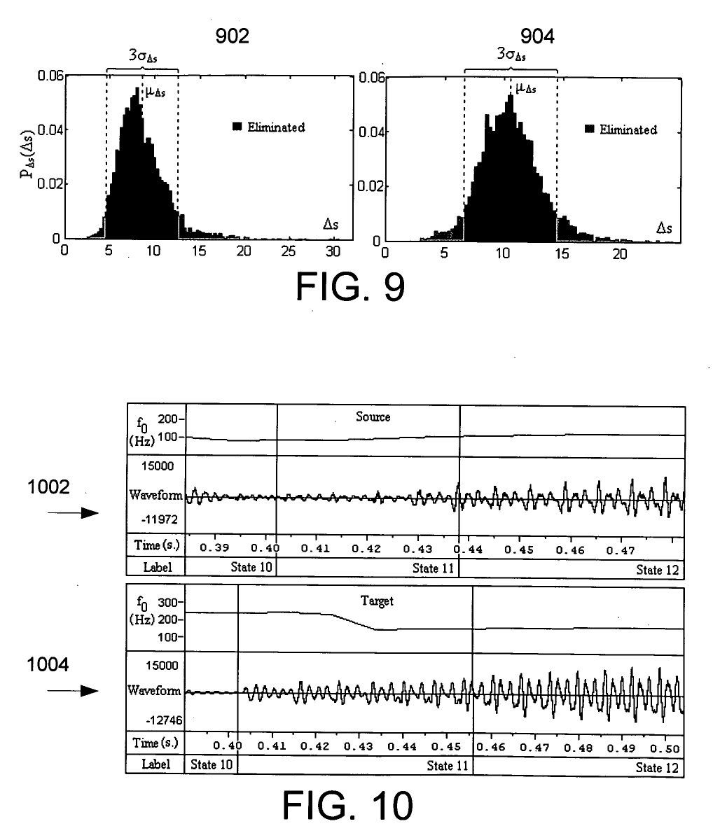

FIG. 9 depicts two graphs showing two examples of histograms for ΔS. Graph 902 shows a male-male source-target speaker pair. Graph 904 shows a male-female source-target speaker pair. The dotted lines represent the bounds of the codebook entries that are kept. Those pairs lying outside the dotted lines are eliminated.

In another embodiment of the invention, the confidence measure is based on the average fundamental frequency, f₀, value. The fundamental frequency is the rate at which a human's vocal chords vibrate and represents the tone of a voice. For example females have higher f₀ when compared to males. If the difference in the average f₀ value between the source and target states is below a predetermined value, the source-target state difference is too insignificant and is eliminated from the codebook. Likewise, if the difference in the average f₀ value between the source and target states is above a predetermined value, the source-target state difference is too different and is eliminated from the codebook. Such an example can be seen in FIG. 10 by comparing state 11 in Graph 1002 representing the source speaker against state 11 in Graph 1004 representing the target speaker.

The difference, Δf, is calculated as the absolute difference between the average source state f₀ value, fₛ, and the average target state f₀ value, fₜ, that is, Δf=|fₛ−fₜ|. The mean and standard deviation of Δf values for all pairs of source and target HMM states are estimated, denoted by μΔf and σΔf respectively. If the distance, Δf, is greater than the mean by N/2 standard deviations, i.e., Δf>μΔf+0.5 NσΔf, the source and target states are acoustically too different, and the pair is eliminated from the code book. If the spectral distance is less than the mean by N/2 standard deviations, i.e., Δf<μΔf−0.5 NσΔf, the source and target states are acoustically too similar and the pair is eliminated from the code book. The variable N is a tuning parameter and again in practice the value of N=3 yields good results, which derives from the fact that assuming the distribution of the data is roughly Gaussian, then a span of 3 σ's (standard deviations) to the right an left of the mean value, μ, covers roughly 86.64% of the all the states so that 14.36% of the states are eliminated. An increase in N can result in more acceptance of more source-target pairs.

FIG. 11 depicts two graphs showing two examples of histograms for Δf. Graph 1102 shows a male-male source-target speaker pair. Graph 1104 shows a male-female source-target speaker pair. The dotted lines represent the bounds of the codebook entries that are kept. Those pairs lying outside the dotted lines are eliminated.

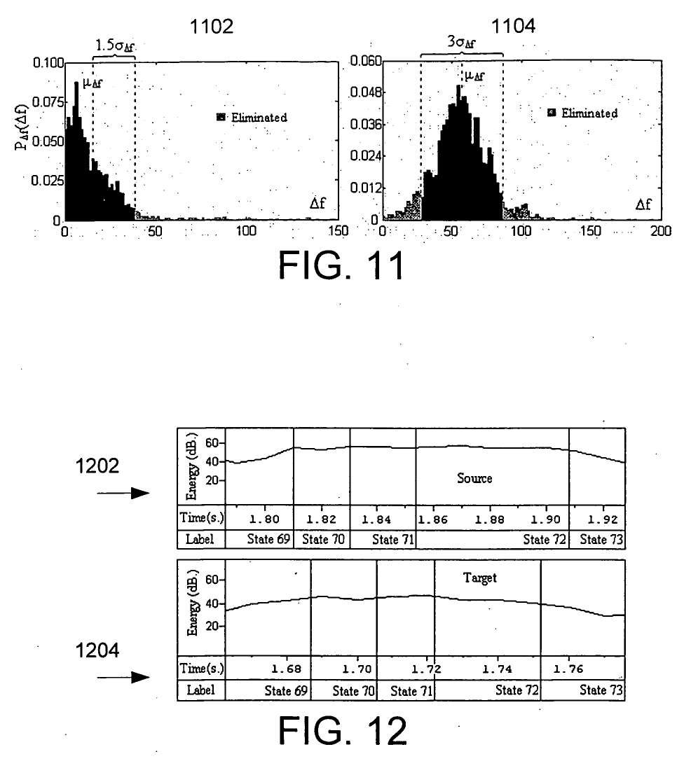

In yet another embodiment of the invention, the confidence measure is based on the average root-mean-square (RMS) energy distance between a pair of source and target HMM states which are computed by computing the average energy within the states. If the difference in the state energy distance between the source and target states is below a predetermined value, the source-target state difference is too insignificant and is eliminated from the codebook. Likewise, if the difference in the state energy distance between the source and target states is above a predetermined value, the source-target state difference is too different and is eliminated from the codebook. Such an example can be seen in FIG. 12 by comparing state 71 in Graph 1202 representing the source speaker against state 71 in Graph 1204 representing the target speaker

The difference, ΔE, is calculated as the absolute difference between the source state average RMS energy, Es, and the target state average RMS energy, Et,, that is, ΔE=|Es−Et|. The mean and standard deviation of ΔE values for all pairs of source and target HMM states are estimated, denoted by μΔE and σΔE respectively. If the state energy distance, ΔE, is greater-than the mean by N/2 standard deviations, i.e., ΔE>μΔE+0.5 NσΔE, the source and target states are acoustically too different, and the pair is eliminated from the code book. If the spectral distance is less than the mean by N/2 standard deviations, i.e., ΔE<μΔE−0.5 NσΔE, the source and target states are acoustically too similar and the pair is eliminated from the code book. The variable N is a tuning parameter and again in practice the value of N=3 yields good results for similar reasons to that described for the preceding confidence measures. An increase in N can result in more acceptance of more source-target pairs.

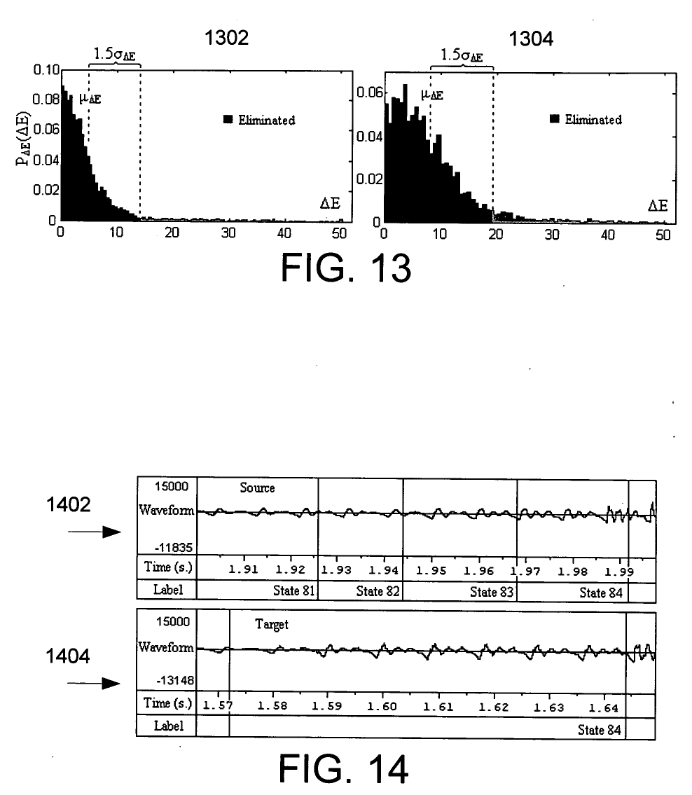

FIG. 13 comprise two graphs showing two examples of histograms for ΔE. Graph 1302 shows a male-male source-target speaker pair. Graph 1304 shows a male-female source-target speaker pair. The dotted lines represent the bounds of the codebook entries that are kept. Those pairs lying outside the dotted lines are eliminated.

In yet another embodiment of the invention, the confidence measure is based on the duration of the source and target HMM states. First, if the duration of either a source or target HMM state is less than a predetermined period, such as 10 ms, the corresponding states are eliminated from the code book. Second, if the duration of either a source or target HMM state is greater than a predetermined period, such as 180 ms, the corresponding states are eliminated from the code book. Third, if the difference in the duration of the source and target states is below a predetermined value, the source-target state difference is too insignificant and is eliminated from the codebook. Fourth, if the difference in the duration of the source and target states is above a predetermined value, the source-target state difference is too different and is eliminated from the codebook. Such an example can be seen in FIG. 14 by comparing 84 in Graph 1402 representing the source speaker against state 84 in Graph 1404 representing the target speaker.

Specifically, the duration difference, ΔD, is calculated as the absolute difference between the source state duration, Ds, and the target state duration, Dt,, that is, ΔD=|Ds−Dt|. The mean and standard deviation of ΔD values for all pairs of source and target HMM states are estimated, denoted by μΔD and σΔD respectively. If the state energy distance, ΔD, is greater than the mean by N/2 standard deviations, i.e. ΔD>μΔD+0.5 NσΔD, the source and target states are acoustically too different, and the pair is eliminated from the code book. If the spectral distance is less than the mean by N/2 standard deviations, i.e. ΔD<μΔD−0.5 NσΔD, the source and, target states are acoustically too similar and the pair is eliminated from the code book. The variable N is a tuning parameter and again in practice the value of N=3 yields good results for similar reasons to that described for the preceding confidence measures. An increase in N can result in more acceptance of more source-target pairs.

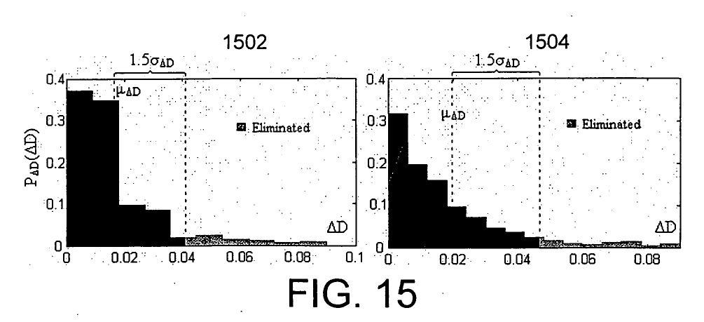

FIG. 15 comprise two graphs showing two examples of histograms for ΔD. Graph 1502 shows a male-male source-target speaker pair. Graph 1504 shows a male-female source-target speaker pair. The dotted lines represent the bounds of the codebook entries that are kept. Those pairs lying outside the dotted.lines are eliminated.

In yet another embodiment of the invention, two or more confidence measures e.g., ΔE and ΔD, are used in combination with one another to eliminate specific source-target pairs.

The application of the confidence measures used to develop the source-target codebooks in the phonemic alignment process yields a codebook which balances the accuracy of other alignment methods without incurring some of the restrictions. Additional confidence measures would become clear to one of ordinary skill in the art can be applied to further refine the phonemic alignment process.

Although the invention has been particularly shown and described with reference to several preferred embodiments thereof, it will be understood by those skilled in the art that various changes in form and details may be made therein without departing from the spirit and scope of the invention as defined in the appended claims.

We claim:

1. A method of speech conversion comprising the steps of:
recognizing phonemes in a source utterance spoken by a source speaker having vocal source speaker vocal characteristics;
subdividing the source utterance into at least one source frames comprising only one phoneme;
matching a source Hidden Markov Model (HMM) state in a source codebook based on source speaker characteristics, said source HMM state corresponding to said at least one source frame;
selecting a plurality of target HMM states in a target codebook associated with the source HMM state based on a transformation from source HMM states to target HMM states, said target codebook based on vocal characteristics of a target speaker;
eliminating one or more target HMM states leaving one or more remaining target HMM states;
averaging the remaining target HMM states to produce a resultant target HMM state; and
assembling a sequence of resultant target HMM states into a target utterance, whereby the target utterance has the voice characteristics of the target speaker.

2. The method of claim 1, wherein the source HMM states in the source codebook and the target HMM states in the target codebook are based on spectral line frequencies.

3. The method of claim 1, wherein the transformation, the source codebook, and the target codebook are generated from a target training set of utterances spoken by the target speaker, and a source training set of utterances spoken by the source speaker, wherein each utterance in the target training set has a corresponding utterance in the source training set.

4. The method of claim 3, wherein the source codebook is generated by selecting each utterance in the source set, recognizing all phonemes in each utterance in the source training set, and training an HMM for each phoneme; and the target codebook is generated by selecting each utterance in the target training set, recognizing all phonemes in each utterance in the target set and training an HMM for each phoneme.

5. The method of claim 4, wherein the transformation is generated by taking each first utterance in the source training set and each corresponding second utterance in the target training set, recognizing a sequence of phonemes in the first utterance, force aligning each first utterance to each corresponding second utterance associating the HMM state in the source codebook for each phoneme in the first utterance with the HMM state in the target codebook for each corresponding phoneme in the second utterance.

6. The method of claim 1, wherein the eliminating one or more of the plurality of target HMM states comprising applying a confidence measure to compare the source HMM state to each of the plurality of target HMM states; and eliminating each of the plurality of target HMM states having a discrepancy outside a predetermined range according to the confidence measure.

7. The method of claim 6, wherein the confidence measure is the distance between a source line spectral frequency vector and a target line spectral frequency vector.

8. The method of claim 6, wherein the confidence measure is the difference in the average f₀ two HMM states.

9. The method of claim 6, wherein the confidence measure is the difference in root mean square energy between two HMM states.

10. The method of claim 6, wherein the confidence measure is the difference in duration of two HMM states.

11. A method of speech conversion comprising the steps of:
generating a source codebook by selecting each utterance in a source training set of utterances spoken by the source speaker; recognizing all phonemes in each utterance in the source training set, and training an HMM for each phoneme;
generating a target codebook by selecting each utterance in a target training set of utterances spoken by the source speaker; recognizing all phonemes in each utterance in the target training set, and training an HMM for each phoneme; and
generating a source to target transformation by taking each first utterance in the source training set and each corresponding second utterance in the target training set, recognizing a sequence of phonemes in the first utterance, force aligning each first utterance to each corresponding second utterance associating the HMM state in the source codebook for each phoneme in the first utterance with the HMM state in the target codebook for each corresponding phoneme in the second utterance;
recognizing phonemes in a source utterance spoken by a source speaker having vocal source speaker vocal characteristics;
subdividing the source utterance into at least one source frames comprising only one phoneme;
matching a source Hidden Markov Model state in a source codebook based on source speaker characteristics, said source HMM state corresponding to said at least one source frame;
selecting a plurality of target HMM states in a target codebook associated with the source HMM state based on a transformation from source HMM states to target HMM states, said target codebook based on vocal characteristics of a target speaker;
eliminating one or more target HMM states leaving one or more remaining target HMM states;
averaging the remaining target HMM states to produce a resultant target HMM state; and
assembling a sequence of resultant target HMM states into a target utterance, whereby the target utterance has the voice characteristics of the target speaker.

12. The method of claim 11, wherein the source HMM states in the source codebook and the target HMM states in the target codebook are based on spectral line frequencies.

13. The method of claim 12, wherein the confidence measure is the distance between a source line spectral frequency vector and a target line spectral frequency vector.

14. The method of claim 12, wherein the confidence measure is the difference in the average f₀ two HMM states.

15. The method of claim 12, wherein the confidence measure is the difference in root mean square energy between two HMM states.

16. The method of claim 12, wherein the confidence measure is the difference in duration of two HMM states.

17. In a speech conversion system, a method of eliminating one or more of a plurality of target HMM states associated a source HMM state, the method comprising the steps of:
applying a confidence measure to compare the source HMM state to each of the plurality of target HMM states; and
eliminating each of the plurality of target HMM states having a discrepancy outside a predetermined range according to the confidence measure.

18. The method of claim 17, wherein the confidence measure is the distance between a source line spectral frequency vector and a target line spectral frequency vector.

19. The method of claim 17, wherein the confidence measure is the difference in the averag f₀ two HMM states.

20. The method of claim 17, wherein the confidence measure is the difference in root mean square energy between two HMM states.

21. The method of claim 17, wherein the confidence measure is the difference in duration of two HMM states.

22. A system for speech conversion comprising:
a processor;
a communication bus coupled to the processor;
a main memory coupled to the communication bus;
an audio input coupled to the communication bus;
an audio output coupled to the communication bus;
wherein the processor receives a source utterance spoken by a source speaker having source speaker vocal characteristics from the audio input; the processor receives instructions from the main memory which causes the processor to:
recognize phonemes in the source utterance;
subdivide the source utterance into at least one source frames comprising only one phoneme;
match a source Hidden Markov Model (HMM) state in a source codebook based onsource speaker characteristics, said source HMM state corresponding to said at least one source frame;
select a plurality of target HMM states in a target codebook associated with the source HMM state based on a transformation from source HMM states to target HMM states, said target codebook based on vocal characteristics of a target speaker;
eliminate one or more target HMM states leaving one or more remaining target HMM states;
average the remaining target HMM states to produce a resultant target HMM state; and
assemble a sequence of resultant target HMM states into a target utterance; and
the processor transmits the target utterance to the audio output.

23. The system of claim 22, wherein the source HMM states in the source codebook and the target HMM states in the target codebook are based on spectral line frequencies.

24. The system of claim 22, wherein the transformation, the source codebook, and the target codebook are generated from a target training set of utterances spoken by the target speaker, and a source training set of utterances spoken by the source speaker, wherein each utterance in the target training set has a corresponding utterance in the source training set.

25. The system of claim 22, wherein the source codebook is generated by selecting each utterance in the source set, recognizing all phonemes in each utterance in the source training set, and training an HMM for each phoneme; and the target codebook is generated by selecting each utterance in the target training set, recognizing all phonemes in each utterance in the target set and training an HMM for each phoneme.

26. The system of claim 25, wherein the transformation is generated by taking each first utterance in the source training set and each corresponding second utterance in the target training set, recognizing a sequence of phonemes in the first utterance, force aligning each first utterance to each corresponding second utterance associating the HMM state in the source codebook for each phoneme in the first utterance with the HMM state in the target codebook for each corresponding phoneme in the second utterance.

27. The system of claim 22, wherein the eliminating one or more of the plurality of target HMM states comprising applying a confidence measure to compare the source HMM state to each of the plurality of target HMM states; and eliminating each of the plurality of target HMM states having a discrepancy outside a predetermined range according to the confidence measure.

28. The system of claim 27, wherein the confidence measure is the distance between a source line spectral frequency vector and a target line spectral frequency vector.

29. The method of claim 27, wherein the confidence measure is the difference in the average f₀ two HMM states.

30. The method of claim 27, wherein the confidence measure is the difference in root mean square energy between two HMM states.

31. The method of claim 27, wherein the confidence measure is the difference in duration of two HMM states.

32. A codebook for the conversion of speech comprising:
a collection of phoneme representations, wherein each representation comprises a plurality of entries.

33. The codebook of claim 32 wherein each of said plurality of entries is a HMM state.
